(19) United States
(12) Patent Application Publication
(10) Pub. No.: US 2019/0207879 A1
(43) Pub. Date: Jul. 4, 2019

(54) TRANSMITTING A MESSAGE BASED ON MACHINE LEARNING SYSTEMS

(71) Applicant: Christian Chouchani, Williamsville, NY (US)

(72) Inventor: CHRISTIAN CHOUCHANI, WILLIAMSVILLE, NY (US)

(21) Appl. No.: 16/233,322

(22) Filed: Dec. 27, 2018

Related U.S. Application Data
(60) Provisional application No. 62/611,255, filed on Dec. 28, 2017.

(51) Int. Cl. H04L 12/58; G06N 5/02; G06N 20/00; G06K 9/62

(52) U.S. Cl. CPC H04L 51/02; G06N 5/02; G06Q 50/01; G06K 9/6267; G06N 20/00

(57) ABSTRACT

The subject disclosure relates to systems, methods, and devices for facilitating transmission of a message associated with a media content item. In an embodiment, the judgment can be dispatched only by an authorized device. In an aspect, disclosed is a system, comprising a memory that stores computer executable components and a processor that executes the computer executable components stored in the memory. In an aspect, the computer executable components can include a transmission component configured to transmit a first set of media data from a first device to a second device. In another aspect, the computer executable components can also include a receiving component configured to facilitate the first device to receive message data from the second device, wherein the message data relates to the first set of media data.

### CROSS REFERENCE TO RELATED APPLICATION

This application claims the benefit of U.S. Patent Application No. 62/611,255 filed on Dec. 28, 2017, and titled “Transmitting a Message Based on an Observation”. The entirety of the disclosure of the aforementioned application is considered part of, and is hereby incorporated by reference in, the disclosure of this application.

### BACKGROUND

Given the propagation and advancement of internet-related technologies, users and consumers utilize such technologies to gain knowledge to particular questions. However, users are often left guessing as to the reliability, trustworthiness or validity of information provided through such sources. Furthermore, online knowledge sources do not provide responses to personalized questions of each user. As such, new technologies are needed to allow users to overcome the issues referenced above.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that employ executable components to facilitate a receipt of an administrative message associated with transmitted media data in accordance with one or more embodiments described herein.

According to an embodiment, a system is provided. The system comprises a processor that executes computer executable components stored in memory. The computer executable components comprise a transmission component configured to transmit a first set of media data from a first device to a second device. Further, the computer executable components comprise a receiving component configured to facilitate the first device to receive message data from the second device, wherein the message data relates to the first set of media data. In another non-limiting embodiment, the computer executable components can comprise a ranking component configured to rank the first set of media data in comparison to one or more other set of media data based on one or more ranking criteria.

According to another embodiment, a computer-implemented method is provided. The computer-implemented method can comprise transmitting, by a system comprising operatively coupled to a processor, a first set of media data from a first device to a second device. The computer-implemented method can also comprise facilitating, by the system, the first device to receive message data from the second device, wherein the message data relates to the first set of media data. In another aspect, the computer-implemented method can also comprise ranking, by the system, the first set of media data in comparison to one or more other set of media data based on one or more ranking criteria. According to yet another embodiment, a computer program product for facilitating transmission of a judgment message is provided.

### BRIEF DESCRIPTION OF THE DRAWINGS

FIG. 1 illustrates a block diagram of an example, non-limiting system that can facilitate a receipt of an administrative message associated with transmitted media data in accordance with one or more embodiments described herein.

FIG. 2 illustrates a block diagram of an example, non-limiting system that can facilitate a receipt of an administrative message associated with transmitted media data in accordance with one or more embodiments described herein.

FIG. 3 illustrates a flow diagram of an example, non-limiting computer-implemented method that can facilitate a receipt of an administrative message associated with transmitted media data in accordance with one or more embodiments described herein.

FIG. 4 illustrates a flow diagram of an example, non-limiting computer-implemented method that can facilitate a receipt of an administrative message associated with transmitted media data in accordance with one or more embodiments described herein.

FIG. 5 illustrates a block diagram of an example, non-limiting operating environment in which one or more embodiments described herein can be facilitated.

FIG. 6 illustrates a block diagram representing an exemplary non-limiting computing system or operating environment in which the various embodiments may be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

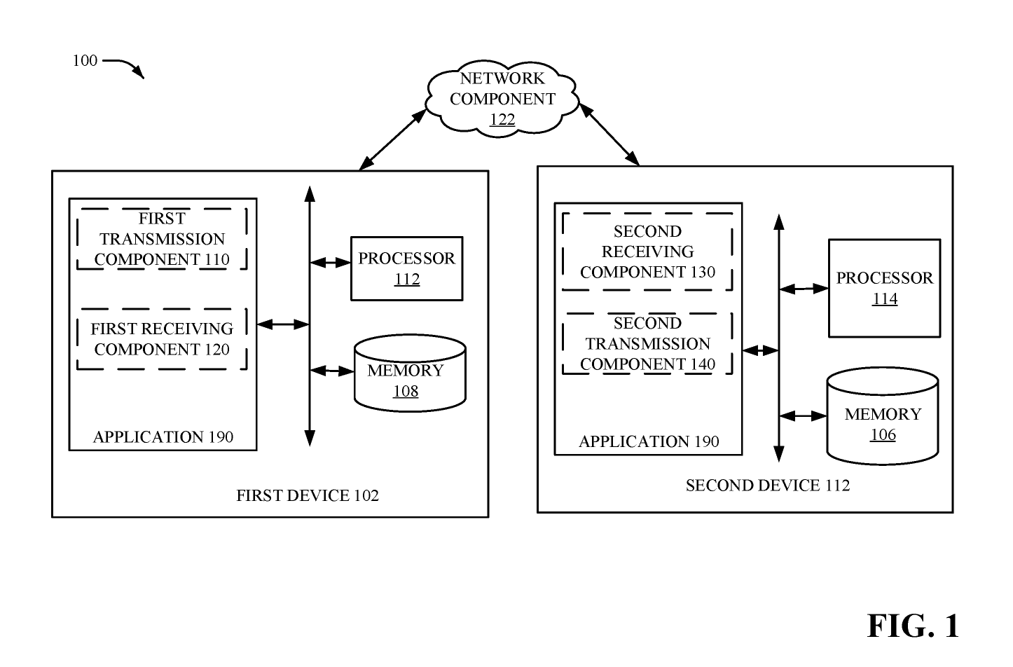

FIG. 1 illustrates a block diagram of an example, non-limiting system 100 that can facilitate a receipt of an administrative message associated with transmitted media data in accordance with one or more embodiments described herein.

In an aspect, system 100 can comprise or otherwise access (via a network component 122 or via storage at the system 100) a first device 102 comprising application 190 capable of executing first transmission component 110 and notification component 120 via processor 112, wherein the application and executable components can be stored in memory 108. In another aspect, system 100 can comprise or otherwise access (via a network or via storage at the system 100) a second device 112 comprising application 190 capable of executing receiving component 130 and second transmission component 140 via processor 114, wherein the application and executable components can be stored in memory 106. In an aspect, processor 112 and processor 114 can respectively execute the computer executable components within respective devices and/or computer instructions stored in memory 108 and/or memory 106 respectively. In an aspect, one or more of the components of system 100 can be electrically and/or communicatively coupled to one or more devices of system 100 or other embodiments to perform one or more functions described herein.

In a non-limiting embodiment, system 100 can comprise a first device 102 and a second device 112 which can be a smart device, a smart phone, a mobile device, a handheld device, a tablet, a computer, a desktop computer, a laptop computer, a monitor device, a virtual reality headset, a portable computing device or another type of computing device. In an aspect, first device 102 (e.g., mobile phone) and second device 112 can communicate via a network component 122) which can represent a data network or a series of interconnected nodes capable of transmitting, receiving, and/or exchanging data (e.g., video data, audio data, image data, etc.). In an aspect, network component 122 can include any one or more of a local area network (LAN), wide area network (WAN), metropolitan area network, storage area network, subnetwork, or other such network type.

In an aspect, system 100 allows for application 190 executing on first device 102 to transmit a first set of media data (e.g., video file, image file, audio file, etc.) to a second device 112. For instance, a user can utilize an application 190 executing on a mobile device (e.g., first device 102) to transmit an image file representing a self-portrait image (e.g., selfie) to second device 112. Furthermore, second device 102 can transmit a responsive message to first device 102 that represents the image as being “approved”, “disapproved”, or “insufficient”. Accordingly, second device 112 can represent an arbiter or judge that presents honest feedback related to the transmitted first set of media data to first device 102. In an aspect, second device 112 can be represented as an oracle or all-knowing character capable of generating honest responses related to an observation or look of media content (e.g., user generated content). In another non-limiting embodiment, second device 112 can transmit (e.g., using second transmission component 140) expanded message data representing a lengthier string of feedback, commentary, or response related to first set of media data. In a non-limiting instance, first device 102 can transmit (e.g., using first transmission component 110) an image of a user face and second device 112 can transmit (e.g., using second transmission component 140) a real-time commentary on the face image as compared to all other user faces of that gender.

In another non-limiting embodiment, second device 112 can receive a notification (e.g., using a notification component not illustrated) that image data has been received (e.g., using receiving component 130). Furthermore, in an aspect, based on a notification of receipt of the image data, first device 102 can transmit (e.g., using second transmission component 140) message data as a response to message data transmitted by first device 102. Accordingly, first device 102 can receive a notification (e.g., using a notification component) of receipt of such message data and can access such message data. In a non-limiting embodiment, second device 112 can represent the only dispatcher of message data and provider of information related to the transmitted set of media data (e.g., image data). A range of users can utilize user devices to transmit set of media data to second device 112 in order to receive message data from second device 112 representing reliable and supreme knowledge disseminated from an all-knowing source.

In a non-limiting instance, system 100 can employ components that facilitate user devices (e.g., first device 102) to retrieve message data representing confirmations and/or validation of a user look based on the set of media data received by second device 112. As such, a group of users can utilize first device 102 and/or several other user devices to transmit pictures of themselves or other users to second device 112 in order to receive an answer as to whether users or models within the transmitted pictures look good, look fair, or need work. In an aspect, second device 112 transmits message data that can represent an opinion void of bias such as an honest view point of how a user looks (e.g., per transmitted image data). As such, user devices can utilize application 190 and application components executed by processor 112 to receive honest assessments or honest commentary (e.g., look of a user image data) related to transmitted media data. Furthermore, second device 112 can be configured to provide message data that act as a personal confidant that provides accurate, honest and real-time message data to a user. In another instance, a user can receive expanded message data that represents detailed feedback of a user look such as a need to color coordinate an outfit, a need for more or less facial makeup, a need to iron a shirt or tie, and other such details to assist a user in increasing its appearance as compared to transmitted image data.

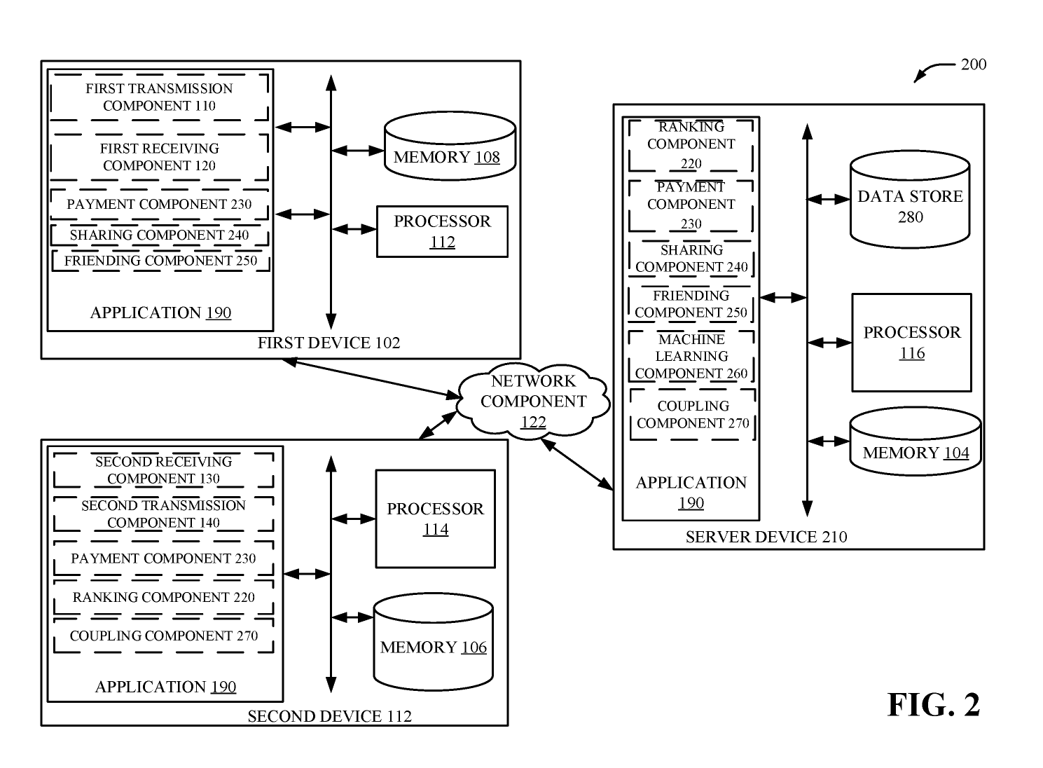

Turning now to FIG. 2, illustrated is a block diagram of an example, non-limiting system 200 that can facilitate a receipt of an administrative message associated with transmitted media data in accordance with one or more embodiments described herein. Repetitive description of like elements employed in other embodiments described herein is omitted for sake of brevity.

In an aspect, FIG. 2 illustrates system 200 that can comprise or otherwise access (via a network component 122 or via storage at the system 100) a first device 102 comprising application 190 capable of executing first transmission component 110 and notification component 120 via processor 112, wherein the application and executable components can be stored in memory 108. In another aspect, system 100 can comprise or otherwise access (via a network or via storage at the system 100) a second device 112 comprising application 190 capable of executing receiving component 130 and second transmission component 140 via processor 114, wherein the application and executable components can be stored in memory 106.

Furthermore, in an aspect, system 200 can include a server device 210 comprising application 190 that can employ a ranking component 220, a payment component 230, a sharing component 240, a friending component 250, a machine learning component 260, a coupling component 270, processor 116, and/or memory 104. In an aspect, processor 112, processor 114, and/or processor 116 can respectively execute the computer executable components within respective devices and/or computer instructions stored in memory 108, memory 106, and/or memory 104 respectively. In an aspect, one or more of the components of system 200 can be electrically and/or communicatively coupled to one or more devices of system 200 or other embodiments to perform one or more functions described herein.

In an aspect, system 200 can utilize server device 210 or other technologies related cloud computing, computers, information technologies, artificial intelligence, data analysis, or other computer technologies. In an aspect, system 200 (and system 100) can employ hardware and/or software to solve problems that are highly technical in nature, that are not abstract and that cannot be performed as a set of mental acts by a human. Further, some of the processes performed may be performed by one or more specialized computers (e.g., e.g., one or more specialized processing units, a specialized computer with an orchestration engine component, etc.) for carrying out defined tasks related to machine learning. In an aspect, system 200 can make use of cloud computing models to facilitate service delivery of message data and enable convenient, on-demand network access (e.g., using application 190) to a shared pool of configurable computing resources (e.g., networks, network bandwidth, servers, processing, memory, storage, applications, virtual machines, and services) that can be rapidly provisioned and released efficiently.

As such, server device 210 can employ application 190 and application 190 components including a ranking component 220 configured to rank the first set of media data in comparison to one or more other set of media data based on one or more ranking criteria. In an aspect, ranking component 210 can rank sets of media data against other sets of media data resulting in generation of a ranking system of image data based on looks as represented in a transmitted message from second device 112. For instance, first devices 102 within a geographic location can transmit media data (e.g., image files) that can be ranked (e.g., by ranking component 220 executing on second device 112 or server device 210) and such ranking can indicate whom is the best-looking user or model depicted within an image in that respective geographic locality. In another non-limiting aspect, ranking component 210 can couple each rank with text data such as ranks 1-10 are “the fairest” in the geographic locality.

In yet another aspect, server device 210 (or first device 112) can employ payment component 230 configured to transmit a payment for the capability of receiving the message data from second device 112. As such, payment component 230 can transmit payment data or financial data related to a purchase of message services related to application 190 operations. For instance, first device 112 can employ a payment component 230 to transmit payment data to server device 210. In an aspect, be stored alongside media data within data store 230. In another aspect, payment data can be used to purchase credits which represent accepted currency by system 100 and system 200. In an aspect, second device 112 and other devices can use such credits to utilize system 100 and system 200 operations such as transmitting media data and receiving message data. In another aspect, second device 112 can transfer (e.g., as a gift) credits to other devices in order to utilize system 100 and system 200 operations.

In another non-limiting embodiment, system 200 can include a sharing component 240 configured to facilitate a transmission of the first set of message data coupled to the received message data to one or more permitted devices. In an aspect, first device 102 can employ sharing component 240 to share received message data or a received status (e.g., associated with transmitted media data) from first device 102 on a social platform or within a system employing a social circle. As such, other users within such social circle can comment, agree, or disagree with the message data received from second device 112. For instance, a first device 102 can share (e.g., using sharing component 240) received message data received from second device 112 on a social platform and such sharing can be performed in a private social circle or a public social circle.

In another non-limiting embodiment system 200 can further comprise a friending component 250 configured to generate a social circle comprising one or more device and the first device 102, wherein the generation of the social circle is based on an authorization granted by the one or more device and the first device. As such, first device 102 can employ friending component 250 to search for other devices representing friends or like-minded users of whom first device 102 can share media data and message data (e.g., received from second device 112) and receive media data and message data from such users. In yet another non-limiting embodiment, system 200 can employ machine learning component 260 configured to classify the first set of media data into a data category based on a comparison of the first set of media data to at least another set of media data based on similarity criteria.

As such, machine learning component 260 can recognize patterns related to media data transmitted by first device 102 and other such user devices and generate message data customized to such media data for transmission to first device 102 and other such respective user devices. For instance, machine learning component 260 can identify several images files that have a similar pattern of too much makeup applied to a model face. Accordingly, machine learning component 260 can generate message data representing a disapproval message as well as commentary that the model can reduce the makeup amount to improve his/her appearance. In other instances, machine learning component 260 can identify several elements associated with a user or model appearance as to allow for customized messages within particular categories for transmission to images having similar pattern characteristics.

In yet another non-limiting embodiment, system 200 can employ a coupling component 260 configured to couple the message data to first set of media content based on the similarity criteria. In an aspect, coupling component 260 can couple or pair message data to media data thus generating combinatorial data for transmission to first device 102. In an aspect, such modified data can be generated in connection with machine learning algorithms such as supervised learning algorithms. In yet another instance, coupling component 260 can be utilized in the absence of machine learning algorithms as well. For instance, second device 112 can transmit message data that is coupled (e.g., using coupling component 260) to media data (e.g., image data).

In a non-limiting embodiment, application 190 can be employed by one or more processor employed on first device 102. In an aspect, application 190 can include one or more login field, join field, information fields (e.g., name, username, password, email, gender, profile picture, payment/credit card details) configured to receive input data (e.g., financial data, user information data, demographic data, etc.). In another aspect, application 190 can receive media data using camera components executing on first device 102 which can facilitate the capture of image data, video data, audio data, and other media data by application 190. In a non-limiting embodiment, image data can't utilize filters such that image data can be judged based on its authentic appearance. In other non-limiting embodiments, image data can utilize filters and other image modifying technology.

In another non-limiting embodiment, application 190 can transmit the media data (e.g., captured by camera components of first device 102) to application 190 executing on second device 112. In another aspect, upon transmission or selection of such image by first device 102, approval data or disapproval data can be received on first device 102 (e.g., from second device 112) indicating whether the transmitted media data is approved or disapproved by second device 112. In another aspect, the message data can include customized media data (e.g., animation, video, etc.). Furthermore, in an aspect, application 190 can allow for transmission of resubmission data (e.g., new media data) or sharing of message data received from second device 112 (or server device 210). In another aspect, application 190 can employ a presentation component that presents credits for purchase. In yet another aspect, each media data item transmitted to second device 112 can be stored at a data store and/or on server device 210. Furthermore, such stored data can be accessed by first device 102 and other devices respectively that submitted such media data.

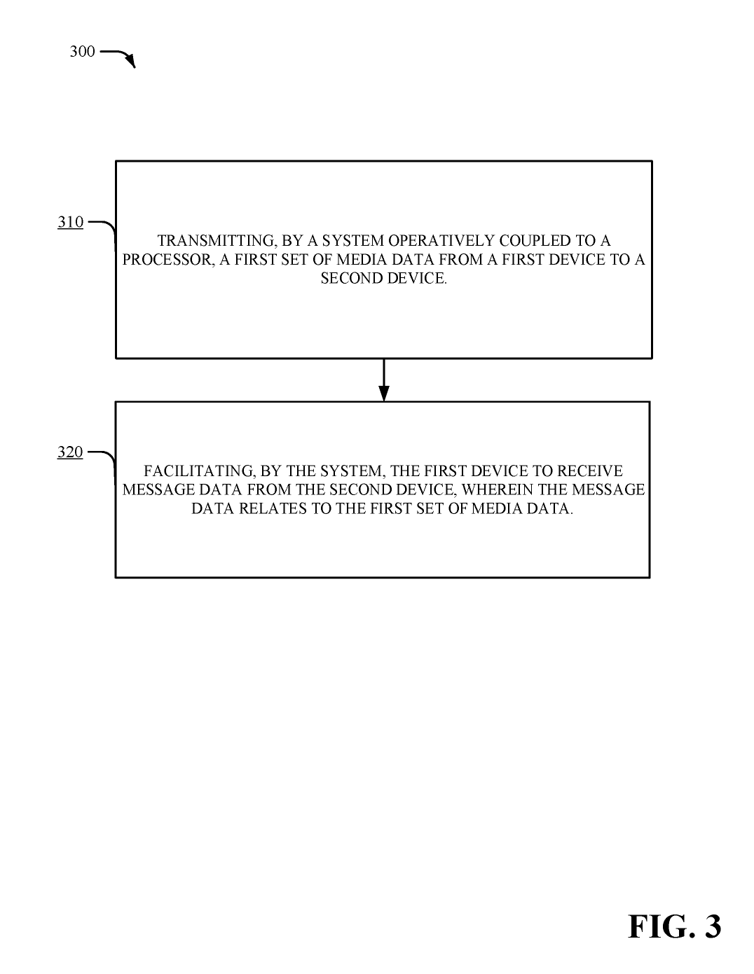

Turning now to FIG. 3, illustrated is a flow diagram of an example, non-limiting computer-implemented method 300 that can facilitate a receipt of an administrative message associated with transmitted media data in accordance with one or more embodiments described herein. Repetitive description of like elements employed in other embodiments described herein is omitted for sake of brevity. In an aspect, one or more of the components described in computer-implemented method 300 can be electrically and/or communicatively coupled to one or more devices.

In some implementations, at reference numeral 310 a system operatively coupled to a processor (e.g., processor 112) can transmit (e.g., using first transmission component 110) a first set of media data from a first device to a second device. At 320, the system can facilitate the receipt (e.g., using receiving component 120) of message data from the second device, wherein the message data relates to the first set of media data.

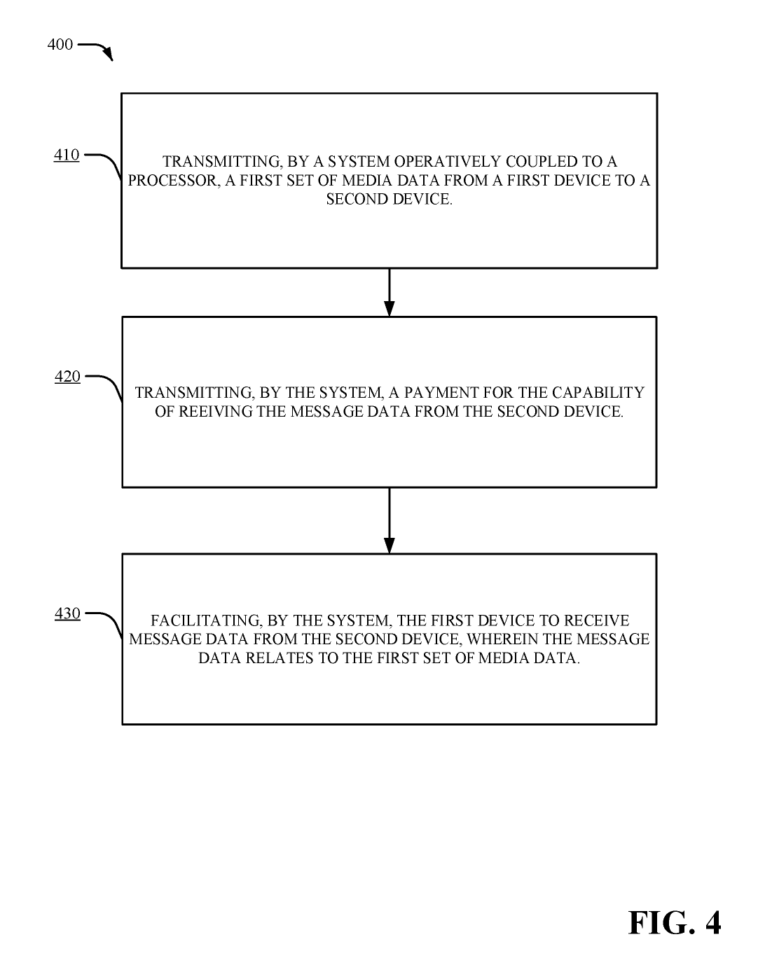

Turning now to FIG. 4, illustrated is a flow diagram of an example, non-limiting computer-implemented method that can facilitate a receipt of an administrative message associated with transmitted media data in accordance with one or more embodiments described herein.

In some implementations, at reference numeral 410 a system operatively coupled to a processor (e.g., processor 112) can transmit (e.g., using first transmission component 110) a first set of media data from a first device to a second device. At 420, the system can transmit a payment (e.g., using payment component 230) for the capability of receiving the message data from the second device. At 430, the system can facilitate the receipt (e.g., using receiving component 120) of message data from the second device, wherein the message data relates to the first set of media data. At 430, the system can transmit a payment for the capability of receiving the message data from the second device. Aspects disclosed herein can be integrated with the tangible and physical infrastructure components of user devices. In an aspect, the systems and methods disclosed can be integrated with physical devices such as tablets, desktop computers, mobile devices, and other such hardware.

Furthermore, the ability to employ iterative machine learning techniques to categorize media data (e.g., such as image files, video files, audio files, etc.) associated with several user devices simultaneously cannot be performed by a human. For example, a human is unable to group image data from based on appearance patterns and customized message commentary associated with such appearance patterns based on machine learning and artificial intelligence comparative techniques in an efficient and accurate manner. Furthermore, a human is unable to simultaneously access and employ grouped image data based on appearance, grouped image data based on physical attire, grouped image data based on beauty, grouped image data based on comparative beauty to attributes in other image data, similarity data associated with grouped and ungrouped appearance data, appearance historical trend data, artificial intelligence generated message data and/or packetized data for communication between a main processor (e.g., using processor 112) and a memory (e.g., memory 108) to simultaneously facilitate the grouping of data associated with thousands of user devices and media data associated with such user devices simultaneously.

With reference to the above-described figures, in an aspect, data stored in memory 108 can comprise data characteristics that eliminate wasteful information and include information that is most indicative of an types of appearances to facilitate grouping operations. For instance, in an aspect, appearance data from other user devices be utilized by system components to update criteria for grouping appearances such as focusing on particular areas within a curve (e.g., that plots appearance data subsets) that suggests with greater likelihood that a subset of data is part of an appearance type group or is not part of an appearance type group. As such, data that is highly representative of similarities or dissimilarities between appearance characteristics of media data are stored in memory 108, memory 106, and memory 104.

Furthermore, such data can be classified to include essential and/or relevant data for making determinations associated with the disclosed systems (e.g., grouping, evaluation, similarities, etc.). Thus, the data stored in disclosed data stores and memory 108 can be structured to allow for efficient and expedient retrieval and access of such data. Furthermore, in some embodiments, such data can be void of non-essential data subsets, which allows for efficient storing such data within memory 108 and data store components that may have limited space. In another aspect, the problems of identifying appearance characteristics (of users) using data grouping techniques can be solved by systems and methods disclosed herein. Thus, the systems, methods, and computer program products disclosed herein solve new and unique problems that did not previously exist.

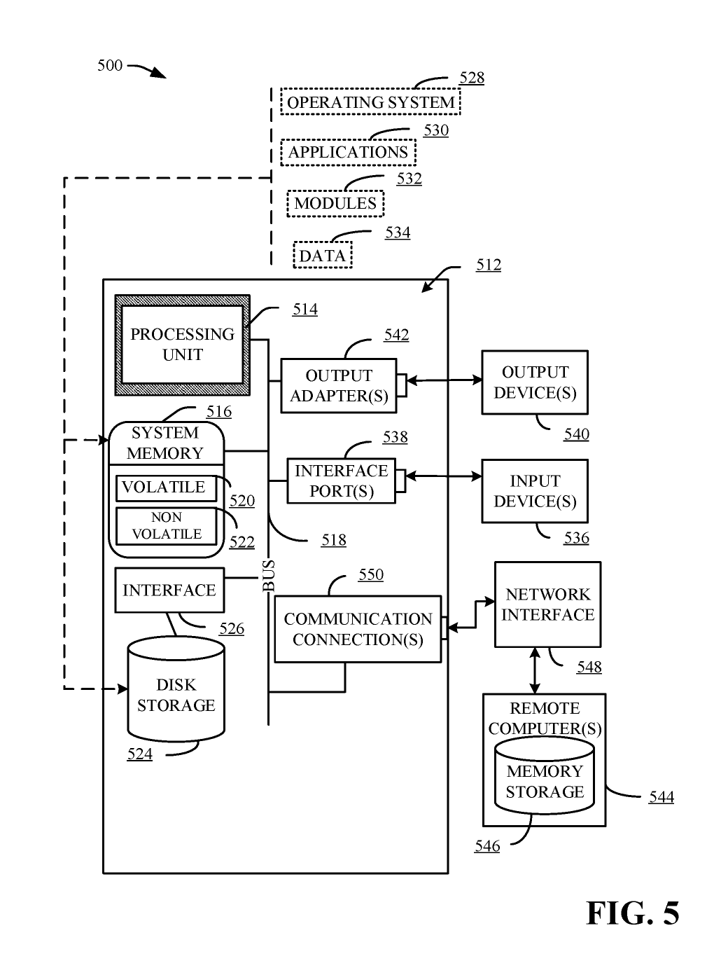

In order to provide a context for the various aspects of the disclosed subject matter, FIG. 5 as well as the following discussion is intended to provide a general description of a suitable environment in which the various aspects of the disclosed subject matter can be implemented. FIG. 5 illustrates a block diagram of an example, non-limiting operating environment in which one or more embodiments described herein can be facilitated. With reference to FIG. 5, a suitable operating environment 500 for implementing various aspects of this disclosure can also include a computer 512. The computer 512 can also include a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514. The system bus 518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 516 can also include volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 520 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 512 can also include removable/non-removable, volatile/non-volatile computer storage media. FIG. 5 illustrates, for example, a disk storage 524. Disk storage 524 can also include, but is not limited to, devices like a magnetic disk drive, floppy disk drive, tape drive, Jaz drive, Zip drive, LS-100 drive, flash memory card, or memory stick. The disk storage 524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 524 to the system bus 518, a removable or non-removable interface is typically used, such as interface 526. FIG. 5 also depicts software that acts as an intermediary between users and the basic computer resources described in the suitable operating environment 500. Such software can also include, for example, an operating system 528. Operating system 528, which can be stored on disk storage 524, acts to control and allocate resources of the computer 512.

System applications 530 take advantage of the management of resources by operating system 528 through program modules 532 and program data 534, e.g., stored either in system memory 516 or on disk storage 524. It is to be appreciated that this disclosure can be implemented with various operating systems or combinations of operating systems. A user enters commands or information into the computer 512 through input device(s) 536. Input devices 536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 514 through the system bus 518 via interface port(s) 538. Interface port(s) 538 include, for example, a serial port, a parallel port, a game port, and a universal serial bus (USB). Output device(s) 540 use some of the same type of ports as input device(s) 536. Thus, for example, a USB port can be used to provide input to computer 512, and to output information from computer 512 to an output device 540. Output adapter 1242 is provided to illustrate that there are some output device 540 like monitors, speakers, and printers, among other such output device 540, which require special adapters. The output adapters 542 include, by way of illustration and not limitation, video and sound cards that provide a means of connection between the output device 540 and the system bus 518. It should be noted that other devices and/or systems of devices provide both input and output capabilities such as remote computer(s) 544.

Computer 512 can operate in a networked environment using logical connections to one or more remote computers, such as remote computer(s) 544. The remote computer(s) 544 can be a computer, a server, a router, a network PC, a workstation, a microprocessor based appliance, a peer device or other common network node and the like, and typically can also include many or all of the elements described relative to computer 512. For purposes of brevity, only a memory storage device 546 is illustrated with remote computer(s) 544. Remote computer(s) 544 is logically connected to computer 512 through a network interface 548 and then physically connected via communication connection 550. Network interface 548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 550 refers to the hardware/software employed to connect the network interface 548 to the system bus 518. While communication connection 550 is shown for illustrative clarity inside computer 512, it can also be external to computer 512. The hardware/software for connection to the network interface 548 can also include, for exemplary purposes only, internal and external technologies such as, modems including regular telephone grade modems, cable modems and DSL modems, ISDN adapters, and Ethernet cards.

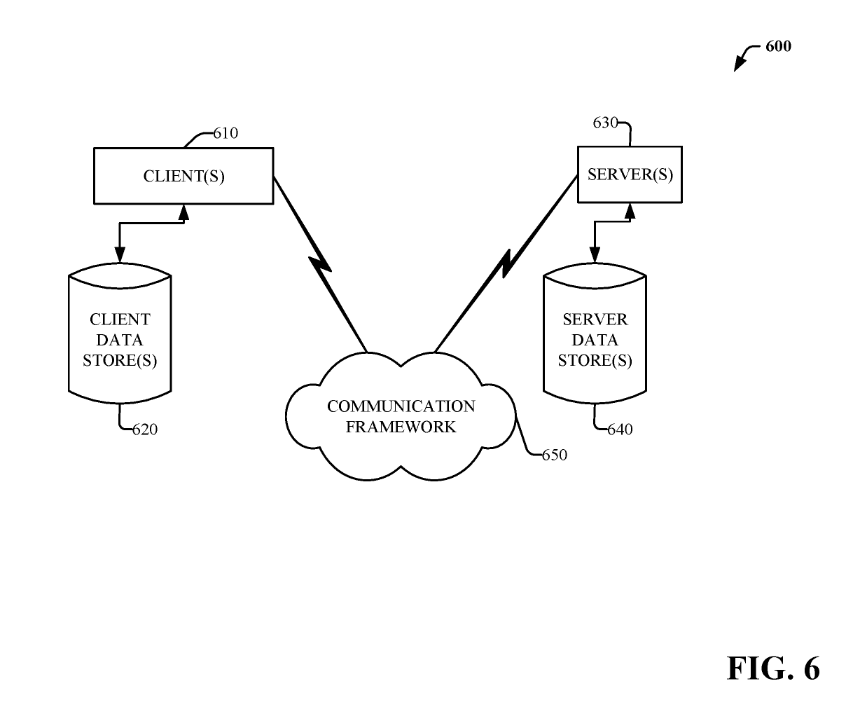

Referring now to FIG. 6, there is illustrated a schematic block diagram of a computing environment 600 in accordance with this disclosure. The system 600 includes one or more client(s) 602 (e.g., laptops, smart phones, PDAs, media players, computers, portable electronic devices, tablets, and the like). The client(s) 602 can be hardware and/or software (e.g., threads, processes, computing devices). The system 600 also includes one or more server(s) 604. The server(s) 604 can also be hardware or hardware in combination with software (e.g., threads, processes, computing devices). The servers 604 can house threads to perform transformations by employing aspects of this disclosure, for example. One possible communication between a client 602 and a server 604 can be in the form of a data packet transmitted between two or more computer processes wherein the data packet may include video data. The data packet can include a metadata, e.g., associated contextual information, for example. The system 600 includes a communication framework 606 (e.g., a global communication network such as the Internet, or mobile network(s)) that can be employed to facilitate communications between the client(s) 602 and the server(s) 604.

Communications can be facilitated via a wired (including optical fiber) and/or wireless technology. The client(s) 602 include or are operatively connected to one or more client data store(s) 608 that can be employed to store information local to the client(s) 602 (e.g., associated contextual information). Similarly, the server(s) 604 are operatively include or are operatively connected to one or more server data store(s) 610 that can be employed to store information local to the servers 604. In one embodiment, a client 602 can transfer an encoded file, in accordance with the disclosed subject matter, to server 604. Server 604 can store the file, decode the file, or transmit the file to another client 602. It is to be appreciated, that a client 602 can also transfer uncompressed file to a server 604 and server 604 can compress the file in accordance with the disclosed subject matter. Likewise, server 604 can encode video information and transmit the information via communication framework 606 to one or more clients 602.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a transmission component configured to transmit a first set of media data from a first device to a second device; and
a receiving component configured to facilitate the first device to receive message data from the second device, wherein the message data relates to the first set of media data.

2. The system of claim 1, wherein the first set of media data represents an image file, a video file, or an audio file.

3. The system of claim 1, wherein the first device represents a central administrative authority permitted to generate the message data.

4. The system of claim 1, wherein the message data represents at least one of an observation, feedback, commentary or criticism of the first set of media data.

5. The system of claim 1, further comprising a payment component configured to transmit a payment for the capability of receiving the message data from the second device.

6. The system of claim 1, further comprising a ranking component configured to rank the first set of media data in comparison to one or more other set of media data based on one or more ranking criteria.

7. The system of claim 1, further comprising a sharing component configured to facilitate a transmission of the first set of message data coupled to the received message data to one or more permitted devices.

8. The system of claim 1, further comprising a friending component configured to generate a social circle comprising one or more device and the first device, wherein the generation of the social circle is based on an authorization granted by the one or more device and the first device.

9. The system of claim 1, further comprising a machine learning component configured to classify the first set of media data into a data category based on a comparison of the first set of media data to at least another set of media data based on similarity criteria.

10. The system of claim 9, further comprising coupling component configured to couple the message data to first set of media content based on the similarity criteria.

11. A computer-implemented method comprising:
transmitting, by a system comprising operatively coupled to a processor, a first set of media data from a first device to a second device; and
facilitating, by the system, the first device to receive message data from the second device, wherein the message data relates to the first set of media data.

12. The computer-implemented method of claim 11, further comprising transmitting, by the system, a payment for the capability of receiving the message data from the second device.

13. The computer-implemented method of claim 11, further comprising ranking, by the system, the first set of media data in comparison to one or more other set of media data based on one or more ranking criteria.

14. The computer-implemented method of claim 11, further comprising coupling the message data to the first set of media content based on similarity criteria.

15. A computer program product for facilitating transmission of a judgment message the computer program product comprising a computer readable storage medium having program instructions embodied therewith, the program instructions executable by a processor to cause the processor to:
receive, by a second device, a set of media data from a first device; and
transmit, by the second device, a message to the first device based on at least one observation of the set of media data.
